(19) United States
(12) Patent Application Publication
(10) Pub. No.: US 2003/0163881 A1
(43) Pub. Date: Sep. 4, 2003

(54) Toothbrush head for an electric toothbrush

(75) Inventors: Georges Driesen, Weilrod (DE); Thomas Fritsch, Eppstein (DE); Michael Harms, Oberursel (DE); Peter Hilfinger, Bad Homburg (DE); Lars Lieberwirth, Glashutten (DE); Armin Schwarz-Hartmann, Wendelsheim (DE)

Correspondence Address: David Howley, The Gillette Company, Prudential Tower Building, Boston, MA, 02199, US

(73) Assignee: Braun GmbH

(21) Appl. No.: 10/361,653

(22) Filed: Feb. 10, 2003

(30) Foreign Application Priority Data
Mar. 2, 2002 (DE) 102 09 320.2

(51) Int. Cl. A61C 17/22

(52) U.S. Cl. 15/22.1; 15/28

(57) ABSTRACT

The present invention relates to a toothbrush head for an electric toothbrush with a brush head holder on which a bristle holder having a bristle cluster is movably arranged. It is provided that locking means are provided on the attachment section of the brush head holder, which, when the brush head holder is pushed onto the handpiece of the toothbrush with a linear, axial motion engage with the engaging means provided thereon. In order to achieve more efficient cleaning, it is further provided that several groups of bristle tufts are fixed on the motorized drivable bristle holder, and are inclined in different directions, and have different cross-sections, preferably also varying from the circular cross-sections, in order to better penetrate the gaps between teeth and effectively remove plaque. Preferably, a stationary bristle holder is arranged on the toothbrush head adjacent the movable bristle holder, to which stationary bristle holder several groups of bristle tufts are affixed and are inclined in different directions, and preferably have differing cross-sections.

The present invention relates to a toothbrush head for an electric toothbrush with a brush head holder on which a bristle holder having a movable bristle cluster is movably arranged. The invention further relates to a handpiece for an electric toothbrush, to which the said toothbrush head may be attached.

Electric toothbrushes having a replaceable toothbrush head are already known. For example, in order to be able to replace a toothbrush head whose bristles are worn, the brush head holder may possess an attachment section for detachable fastening to the handpiece of the toothbrush and be provided with a drive coupling for coupling the bristle holder to a drive arranged on the handpiece. The brush head holder together with its attachment section is locked to a complementary attachment section on the handpiece so that the toothbrush head is affixed firmly to the handpiece and may transfer the corresponding forces when cleaning.

It has been suggested to provide a bayonet catch between the brush head holder of the replaceable toothbrush head and the handpiece of the electric toothbrush. After the replaceable toothbrush head is moved axially, it is then rotated about its longitudinal axis so that the bayonet catch engages. With regard to the drive coupling, it has already been suggested to use a split driveshaft, wherein one part of the driveshaft is arranged in the toothbrush head and the other part in the brush tube of the handpiece. Both driveshaft parts are furnished with a coupling member at their ends. When they are coupled, the driveshaft parts spring radially so that the coupling members slide over one another and lock in order to bolt the driveshaft parts longitudinally, since the driveshaft moves back and forth longitudinally when it is in operation.

However, the replaceable toothbrush heads currently in use are capable of improvement in respect of their attachment to the handpiece and their coupling to the drive train on the handpiece. In particular, in cases where the transmission elements oscillate perpendicularly to the longitudinal direction of the toothbrush, and not in the longitudinal direction, the coupling solutions known hitherto are unsuitable, and furthermore handling is awkward when attaching and detaching the toothbrush heads that are currently known.

The object underlying the present invention, therefore, is to create an improved toothbrush head and an improved handpiece for an electric toothbrush, which avoids the disadvantages of the prior art, and advantageously improves thereon. Preferably, a solution should be created that is simple to handle and cheap to manufacture, and that allows toothbrush heads to be attached to and removed from the handpiece of the electric toothbrush quickly and easily.

The object is solved according to the invention with a toothbrush head in accordance with claim 1. Regarding the handpiece, the object outlined in the aforegoing is solved with a handpiece for an electric toothbrush in accordance with claim 50. Preferred embodiments of the invention are described in the subordinate claims.

The invention provides that locking means be furnished on the preferably essentially rigid attachment section of the brush head holder, which locking means engage with the engaging means provided on the handpiece of the toothbrush when the brush head holder is pushed in an axially linear direction thereonto. The toothbrush head is thereby securely attached thereto without rotation as is required with a bayonet catch, by simply sliding it axially onto the handpiece. In particular it is provided that the locking means is detachable by radial pressure on the brush head holder and/or on the handpiece of the toothbrush, so that a replaceable toothbrush head may be removed from the handpiece in a simple one-handed operation. It merely requires pressing with the thumb in the area of locking means on the brush head holder and pushing forward while holding the handpiece of the toothbrush in the palm of the hand with the other fingers. Rotation is not necessary for removing the toothbrush head. Naturally, clamping elements may also be provided instead of a locking means, and which may be used to secure the brush head holder by frictional or clamping force as it is slipped axially onto the handpiece. In this case, it may be possible to dispense with the locking means.

A particularly suitable locking means is a flexible tongue with a latch hook and a corresponding locking undercut or recess in the opposite attachment part, with which the flexible tongue may engage with its latch hook. At all events the flexible tongue may be provided on the handpiece and the locking recess on the brush head holder. However, it is preferred to arrange the flexible tongue on the brush head holder such that the locking engagement may be released and the brush head may be removed at the same time by the application of radial pressure to the brush head holder in the area of the flexible tongue. The flexible tongue flexes radially inwards under the pressure so that the latch hook snaps out of the locking recess.

The attachment sections of the toothbrush head and the handpiece that are pushed over one another are preferably constructed so that the locking means must only trap forces in the axial direction, i.e. in the longitudinal direction of the toothbrush. Bending and/or torsional forces that are applied to the joint between the toothbrush head and the handpiece are trapped by the intrinsic properties of the joint or attachment means and in particular a sliding guide may be provided between the brush head holder and the handpiece in the form of longitudinal ribs and longitudinal grooves, which are pushed into one another. The positive locking, slide-on guide secures the handpiece and the toothbrush head against distortion and also transfers bending forces when cleaning the teeth. The sliding guide is preferably conformed so that the toothbrush head can only be attached on in one position of the rotation. In this way, it forms a rotational engagement code that prevents the toothbrush head from being attached in the wrong alignment.

According to a further aspect of the present invention, the toothbrush head is distinguished in respect of its drive coupling, which may help to couple the bristle holder to the drive train on the handpiece, in that only forces and movements that are perpendicular to the longitudinal axis of the toothbrush may be transferred from the drive train on the handpiece. The drive coupling possesses meshing elements that are effective in a perpendicular direction, so that it is also possible to couple drive transfer means that move perpendicularly to the longitudinal direction of the toothbrush. The elimination of a drive train coupling that is effective in the longitudinal direction allows the coupling elements to be constructed very simply. Of course, such a drive coupling construction is also particularly advantageous if locking between the brush head holder and the handpiece is assured not axially but, for example by a bayonet lock or similar. However, particular advantages may be gained with regard to locking, since the elimination of a longitudinal coupling arrangement means that no forces are transferred longitudinally and therefore cannot be exerted on the locking arrangement.

In a preferred embodiment of the invention, the coupling point of the drive train is directly on the bristle holder and there is no individual, separate transmission element in the toothbrush head, i.e. the drive element on the handpiece is coupled directly with the bristle holder. Thus advantageously, a transmission element does not need to be discarded when a worn out toothbrush head is replaced, and the replacement part, i.e. the toothbrush head, is distinguished by the fact that it is inexpensive to produce.

The drive element that is coupled to the bristle holder may particularly have the form of a drive rocker, that is tiltably arranged in the handpiece housing. A multiaxial, tiltably arranged drive rocker may be provided that is drivable via a cam located on the motor shaft such that its motion describes a double conical path. The end of the drive rocker on the toothbrush head side protrudes from the frontal face of the handpiece housing so that it may be coupled with the bristle holder of the toothbrush head.

In particularly advantageous manner, a recess is conformed in the bristle holder as the drive coupling, and with which the drive element on the handpiece—particularly the protruding end of the drive rocker—engages when the toothbrush head is attached to the handpiece.

In order to facilitate the engagement, a coupling guide may be attached to the bristle holder to align the bristle holder and the drive element on the handpiece with each other for mounting the toothbrush head. Particularly on the one hand a travel limiter may be attached to the bristle holder so that its drive coupling in the form of a recess is always facing the drive rocker, meaning that it is always correctly aligned for mounting. On the other hand, insert bevels may be provided on the bristle holder to grip the drive element on the handpiece, particularly the end of the drive rocker facing the bristle holder when the toothbrush head is mounted.

In an especially preferred embodiment of the invention, a lengthwise slit, which is flared in the direction of mounting, is provided in a housing surface of the bristle holder as the drive coupling. The drive rocker end facing the bristle holder, which is located in the handpiece, preferably has a hemispherical construction. The sides of the recess in the bristle holder run along the ball-shaped head of the drive rocker as the drive rocker moves back and forth.

In an improvement to the invention, the bristle holder is arranged rotatably about a pivot pin perpendicular to the longitudinal axis of the brush head, and preferably may only be rotated through a restricted angle, thereby ensuring that the bristle holder remains aligned for coupling. The bristle holder may be arranged so that it cannot be moved about the pivot pin. The lengthwise slot-shaped recess in the bristle holder, in which the drive rocker moves, compensates for the component of the double conical path of the drive rocker in the direction of the bristle holder's pivot pin. The drive coupling may thus move freely relative to the bristle holder pivot pin. The bristle holder is driven only in rotating oscillation.

In an alternative improvement of the invention, the bristle holder may be arranged so that besides its rotating ability, it may be translatably movable in the direction of its pivot pin, thus enabling a reciprocating motion. In this case the drive coupling is furnished with meshing mechanisms for the transfer of drive motions and forces in the direction of the pivot pin. The double conical motion of the drive rocker is thus converted both to a reciprocating motion of the bristle holder and to rotating oscillation of the bristle holder about its pivot pin. The coupled joint is constructed as a spherical pair in kinematic terms. Instead of the lengthwise slot described previously, a round or possibly slightly oval or elliptical recess may be provided in the housing surface of the bristle holder to transfer the orbital motion to the end of the drive rocker opposite the bristle holder both transverse and parallel to the bristle holder's pivot pin. In this case also, the recess is flared in the direction of the drive rocker, for example by bevels, curves or similar to give a funnel shape.

Toothbrush heads for electric toothbrushes according to the prior may also be improved with respect to their cleaning effect. In the case of manual toothbrushes, it was already known (c.f. for example German Patent No. DE 29823799 U1) to arrange bristle tufts with differing cross-sections and at differing inclinations, in order to better penetrate the gaps between teeth. With electrically driven toothbrushes or bristle clusters, as far as the authors are aware, such inclined bristle tufts have until now been avoided. Regarding the pivot pin of oscillating rotating or simply rotating bristle clusters, the bristle tufts have hitherto been aligned parallel to the pivot pin, so that the alignment does not change with rotation. In order to achieve an improved cleaning effect, it has already been suggested to combine a rotating oscillating bristle cluster with a fixed bristle cluster. Thus each bristle cluster formed a working surface having a central depression, that is the bristles on the outer edge were longer than those in the middle. However, precisely this measure prevented optimal contact with the tooth surface. Moreover, the arrangement of a fixed bristle cluster next to a moving bristle cluster often causes the user to use the toothbrush like a manual toothbrush and move it backwards and forwards as if polishing shoes. However, this impairs the cleaning effect of the rotating bristle cluster.

Therefore, the further object of the present invention is to provide an improved toothbrush head for an electric toothbrush that avoids the disadvantages of the prior art and improves the latter in advantageous manner. Preferably, a further improved cleaning effect should be achieved.

This object is solved according to the invention by a toothbrush head in accordance with claim 13. Preferred embodiments of the invention are described in the subordinate claims.

The invention suggests that several groups of bristle tufts be affixed to the motor-drivable bristle holder. These bristle tufts are inclined in different directions. The bristle tuft groups inclined in different directions may have varying cross-sections, may preferably also have cross-sections differing from the circular, so as to be better able to penetrate the gaps between teeth and remove plaque effectively.

A stationary bristle holder is preferably attached to the toothbrush head beside the movable bristle holder, and several groups of bristle tufts are also fixed on the stationary bristle holder, these tufts being inclined in various directions. The bristle tuft groups inclined in various directions may preferably have differing cross-sections, particularly cross-sections other than the circular. The bristle tufts of the fixed bristle cluster are preferably inclined in different directions than the bristle tufts on the driven bristle cluster.

On the driven, preferably oscillatory rotating bristle holder, bristle tufts are advantageously provided that are inclined and/or parallel to the axis of motion of the bristle holder, and have an oblong, oval or rectangular cross-section. Bristle tufts with such cross-sections are preferably also provided on the stationary bristle holder in order to achieve a more effective cleaning effect.

In a improvement to the invention, bristle tufts are provided on the movable bristle holder and/or on the stationary bristle holder, the distal working ends of which extend to different heights over the bristle holder. The bristle tufts may have different lengths. Particularly, bristle tufts with various cross-sections may be of various lengths. On the fixed bristle cluster it is useful to configure the bristle tufts at the outer edge with various lengths depending on the cross-section area. The bristle tufts with thinner cross-section are preferably longer than the bristle tufts with thicker cross-sectional surface. Also, bristle tufts with circular cross-section may be shorter than bristle tufts having an oval or oblong cross-section.

On the driven bristle cluster, it is useful to provide longer bristle tufts at the marginal areas, which are positioned roughly in the region of the longitudinal midplane of the toothbrush when this is bristle cluster is in a rotationally neutral position, whereas shorter bristle tufts are arranged in the mid-section of the bristle cluster and in the marginal sections that lie to the right and left of the longitudinal midplane of the toothbrush. The longer bristle tufts of the driven bristle cluster preferably have an oblong or an oval cross-section. They may be arranged inclined to the surface of the bristle holder, and preferably at an acute angle in a radial direction about the bristle cluster's pivot pin.

In order to obtain optimal cleaning results, bristle tufts are disposed on the movable bristle holder in a wide range of inclination directions. A first group of bristle tufts on the movable bristle holder having approximately circular cross-section may extend parallel to the axis of motion of the bristle holder, and the bristle tufts of this group are preferably arranged approximately centrally on the bristle holder. A second group of bristle tufts on the movable bristle holder, having a preferably elongated, especially oval cross-section, may also extend parallel to the axis of motion of the bristle holder, these bristle tufts being preferably arranged beside the bristle tufts with round cross-section previously described, namely before and after the bristle tufts of the first group in the longitudinal direction of the toothbrush. The longitudinal axis of the oval cross-section of the bristle tufts of the second group preferably runs perpendicular to the longitudinal direction of the toothbrush.

In an improved embodiment of the invention, bristle tufts are provided on the movable bristle holder that are inclined at a acute angle radially outward with respect to the axis of motion. A third group of bristle tufts having elongated, preferably oval cross-section is similarly outwardly inclined, the bristle tufts being arranged to the left and right of the non-inclined bristle tufts of the first and second group in the longitudinal direction of the toothbrush particularly approximately along a line passing perpendicularly through the bristle holder's pivot pin. A fourth group of bristle tufts, which is also inclined radially outwards in the manner described, may have a round cross-section and may be arranged adjacent to the non-inclined bristle tuft in the middle of the bristle holder. They may preferably be set in diametrically opposed pairs and may still be located within the outermost row of bristle tufts on the movable bristle holder.

Finally, the bristle holder may have a ring of bristle tufts disposed in an outer circle, which are inclined at an acute angle in radial direction about the bristle holder's pivot pin. Bristle tufts that are inclined in such a manner are preferably arranged in pairs having opposite inclinations.

A fifth group of bristle tufts on the moveable bristle holder, which is inclined in a radial direction in the manner described, may have an elongated, especially oval cross-section. They are preferably arranged in a sector of the bristle holder that lies on the longitudinal midplane of the toothbrush in an unrotated position of the bristle holder. They therefore lie approximately toward the front and rear ends of the movable bristle cluster in longitudinal direction of the toothbrush. These bristle tufts are preferably longer than all the other bristle tufts on the moveable bristle cluster.

Finally, a sixth group of bristle tufts may be provided, inclined in the described manner in a radial direction on the movable bristle holder about its pivot pin, and having an approximately circular cross-section. They are arranged to best effect approximately along the circumference of the bristle tufts of the fifth group, and therebetween.

The angle of inclination of the inclined bristle tufts on the driven bristle holder is preferably in a range from 4° to 9°, particularly approximately 5.5° to 7.5°.

The bristle tufts on the stationary, rigid bristle cluster, which is preferably arranged beside the movable bristle cluster and closer to the handpiece of the toothbrush, are also arranged with different angles of inclination. Preferably, two inclination angles are provided for the bristle tufts of the solid bristle cluster, and may be defined in one plane or in parallel planes and may be arranged in opposition to each other. Bristle tufts that are forwardly inclined and backwardly inclined relative to the longitudinal direction of the toothbrush may particularly be provided, and each inclined at an acute angle with respect to the plane of the bristle holder.

The angles of inclination are preferably in a range from 10° to 20°, particularly approximately 12° to 15°. Bristle tufts that are located on the midplane of the toothbrush are preferably inclined towards the handpiece, while outlying bristle tufts may be inclined forward towards the movable bristle cluster.

In an improved embodiment of the invention, not all bristle tufts in one inclination direction have the same cross-section and/or length. Bristle tufts having various oval cross-sections may be provided in a middle region on the longitudinal midplane, wherein bristle tufts having a smaller cross-section area are longer than those with a larger cross-section area. The reason for this is that the bristle tufts with smaller cross-sectional area are less rigid and therefore can flex better so that despite their greater length they do not prevent the shorter bristle tufts from coming into contact with the tooth-surfaces.

Bristle tufts with bristles having oval cross-section and bristle tufts with bristles having an approximately round cross-section may be provided in marginal areas of the fixed bristle cluster to the right and left of the longitudinal midplane of the toothbrush, wherein the bristle tufts with round cross-section are shorter than the tufts with the oval cross-section. Preferably the round bristle tufts and the oval bristle tufts are arranged alternatingly.

According to a preferred embodiment of the invention, the bristle tufts on the fixed bristle cluster are arranged approximately in rows one behind the other, and in three rows. The middle row may be inclined backwardly towards the handpiece while the two outer rows are inclined forward towards the movable bristle cluster.

In an improvement of the invention, the bristle tufts define exactly two working heights for both the fixed bristle cluster and the driven, moveable bristle cluster. The distal ends of the longer bristle tufts on the fixed bristle cluster and the distal ends of the longer bristle tufts on the movable bristle cluster preferably are on one level. In the same way, the shorter bristle tufts on the fixed bristle cluster and the shorter bristle tufts on the driven bristle cluster are on a second level, which is lower than the first level.

However, the length of the bristle tufts on the fixed bristle cluster increases towards the handpiece, although the distal ends of the bristle tufts lie on two levels in the manner described. The reason for this is that the fixed bristle holder slopes downwardly towards the handpiece. Those bristle tufts that are situated closer to the handpiece are of greater length and accordingly greater flexibility. This structure affords better accessibility for the toothbrush, which means a better result when cleaning the back teeth. The toothbrush also fits better into the arch of the front teeth, both inside and out. The fixed bristle holder is preferably arched and curved in three dimensions. The curvature may also extend transversely to the longitudinal direction of the toothbrush. The length of the bristles also increases transversely to the lengthwise direction.

The transverse camber of the bristle holder essentially prevents the plastic body from coming into contact with the gums when cleaning the teeth.

The fixed bristle cluster preferably includes bristles with various properties. In an improvement of the invention, bristles in the bristle tufts on the outer edges may have a larger diameter than bristles in the inner, more central bristle tufts. According to an especially advantageous embodiment, the outer bristles have for example a diameter from (7±1)×10⁻³ inches (1 mil=10⁻³ inch≈0.0254 mm), while the inner bristles have a diameter for example from (6±1)×10⁻³ inch. The bristles are preferably made of nylon.

In an improvement of the invention, the outer bristles in the fixed bristle cluster are developed to indicate wear. In this way, excessive wear of the toothbrush may be easily recognized.

In an improvement of the invention, the toothbrush head is made from POM. This makes it possible to create a compact toothbrush head since the required wall thickness may be reduced. With toothbrush heads that are made from ABS or PP, the bracing holes for the round bristle tufts must be twice as deep as the diameter of the bristle tuft. For bristle tuft bracing holes having a diameter in the range from approximately 1.5 mm to 1.7 mm, the toothbrush head must have a minimum wall thickness of approximately 3.7 mm to 4.1 mm, so that toothbrush heads made from ABS or PPS become bulky. In contrast, if POM is used, the necessary wall thickness can be reduced considerably, by about 0.6 mm to 1.0 mm in the example cited. A correspondingly smaller toothbrush head enables difficult areas of the mouth to be reached and more easily and thus cleaned more effectively.

Further advantages, application capabilities and advantageous characteristics of the invention will become clear from the following description of an embodiment of the invention, as represented in the drawing. All the characteristics described or represented constitute the object of the invention either separately or in any combination thereof, regardless of the manner in which they represented in the claims or references thereto, and regardless of their formulation or representation in the description or the drawing. In the drawing:

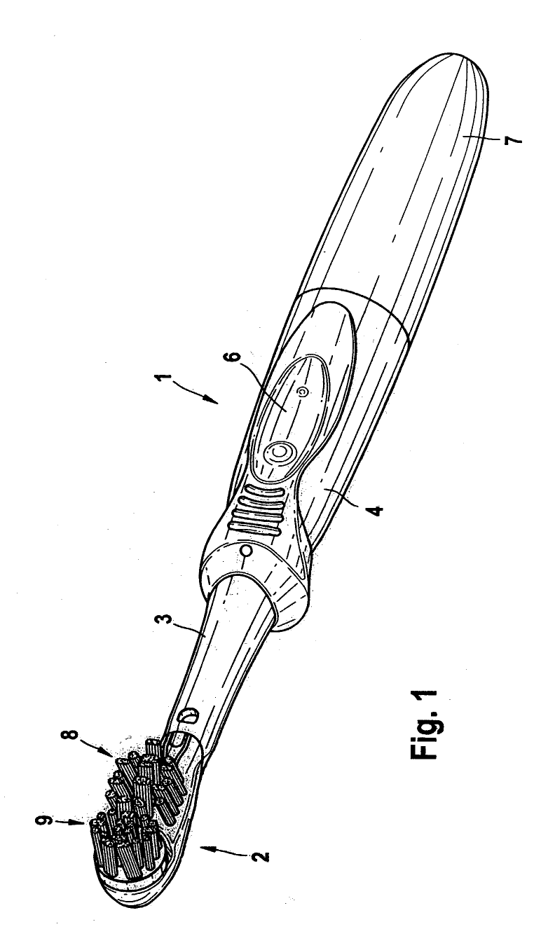

FIG. 1 is a perspective view of an electric toothbrush with a brush head that may be detachably attached to the handpiece of the toothbrush and that has one rotatably drivable bristle cluster and one fixed bristle cluster according to a preferred embodiment of the invention,

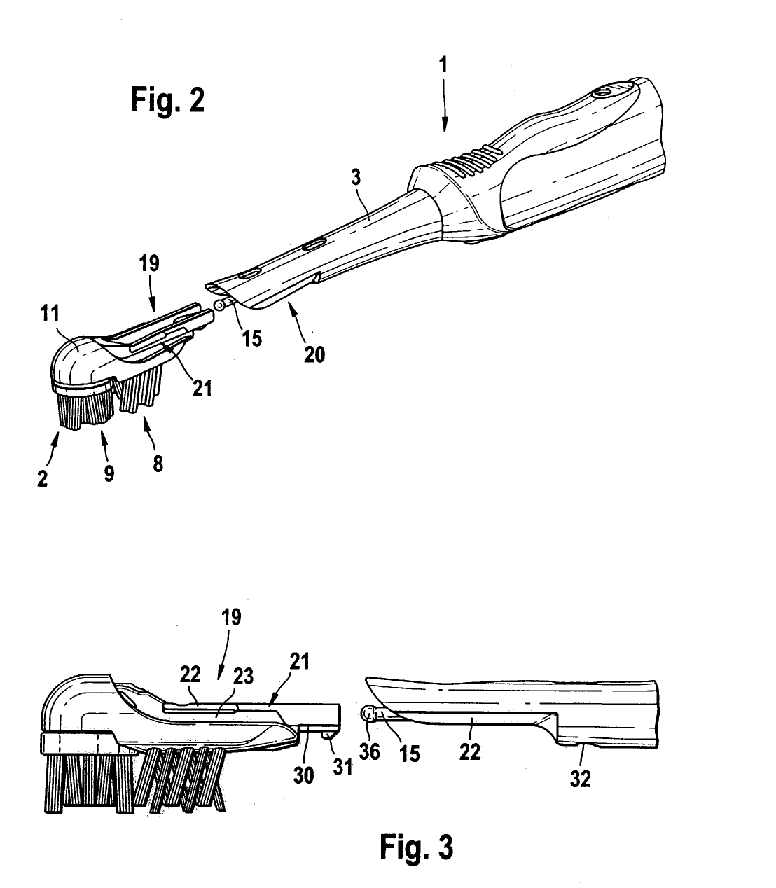

FIG. 2 is a perspective, partially exploded view of the toothbrush of FIG. 1, showing the toothbrush head removed from the handpiece,

FIG. 3 is a partial side view of the toothbrush, showing the toothbrush head removed from the handpiece as in FIG. 2,

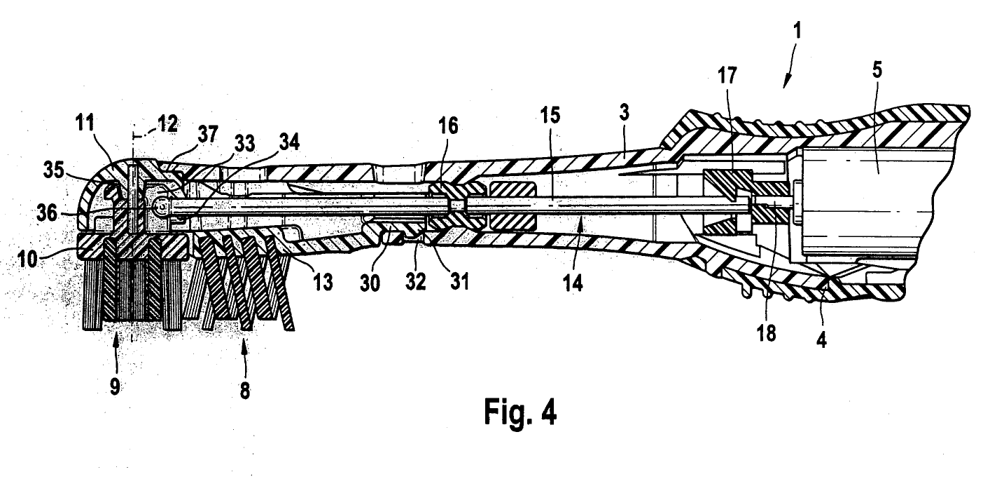

FIG. 4 is a cutaway longitudinal section through the toothbrush of the preceding Figs. showing the toothbrush head mounted on the handpiece,

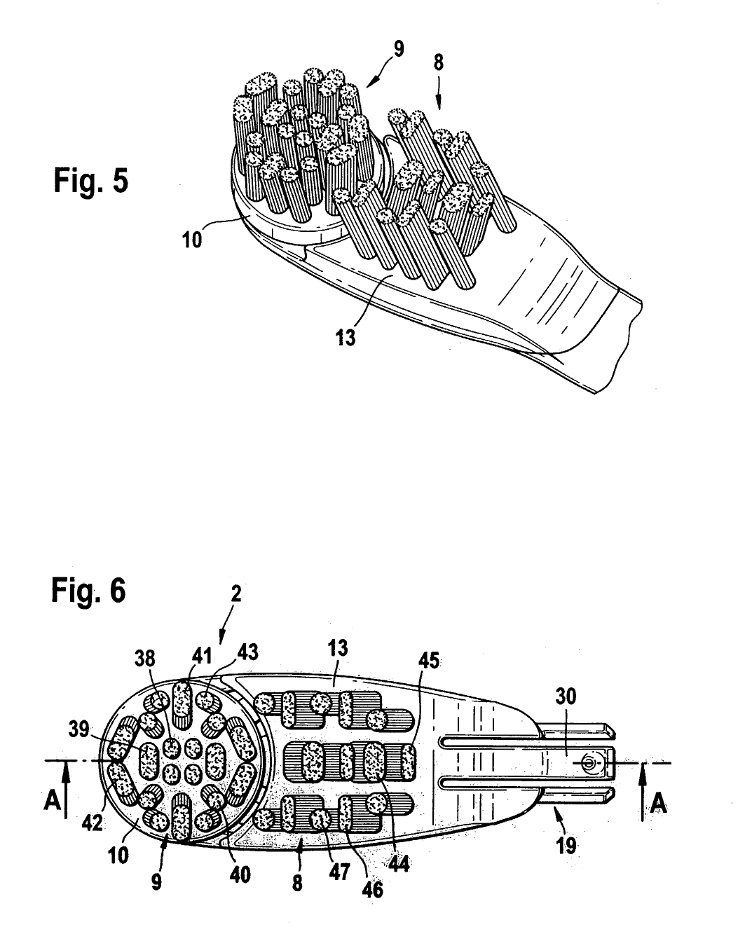

FIG. 5 is a perspective, partial representation of the toothbrush head, showing the arrangement of the bristle tufts in both bristle clusters,

FIG. 6 is a plan view of the bristle clusters in the toothbrush head of the preceding figures,

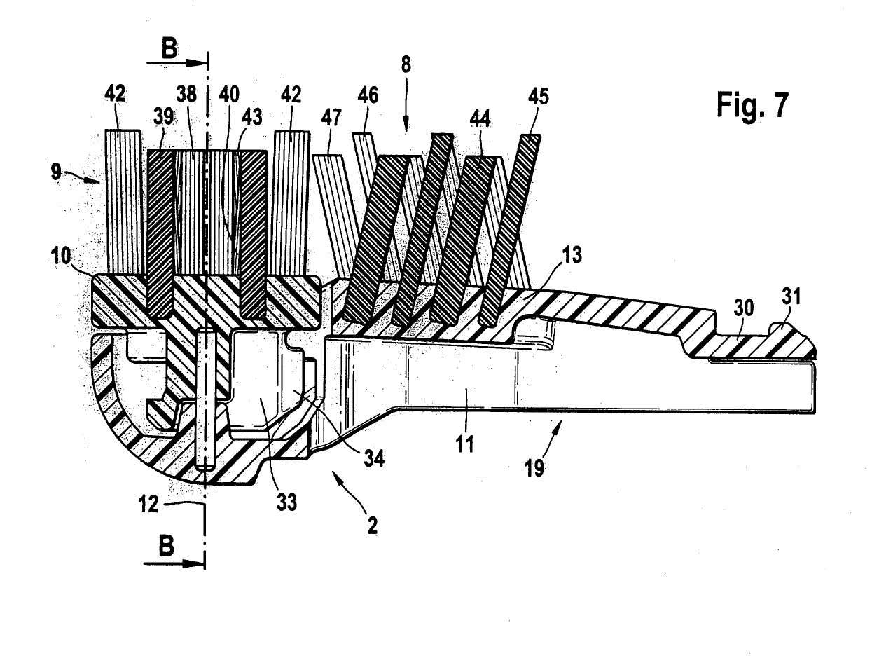

FIG. 7 is a longitudinal section through the toothbrush head along line A-A in FIG. 6,

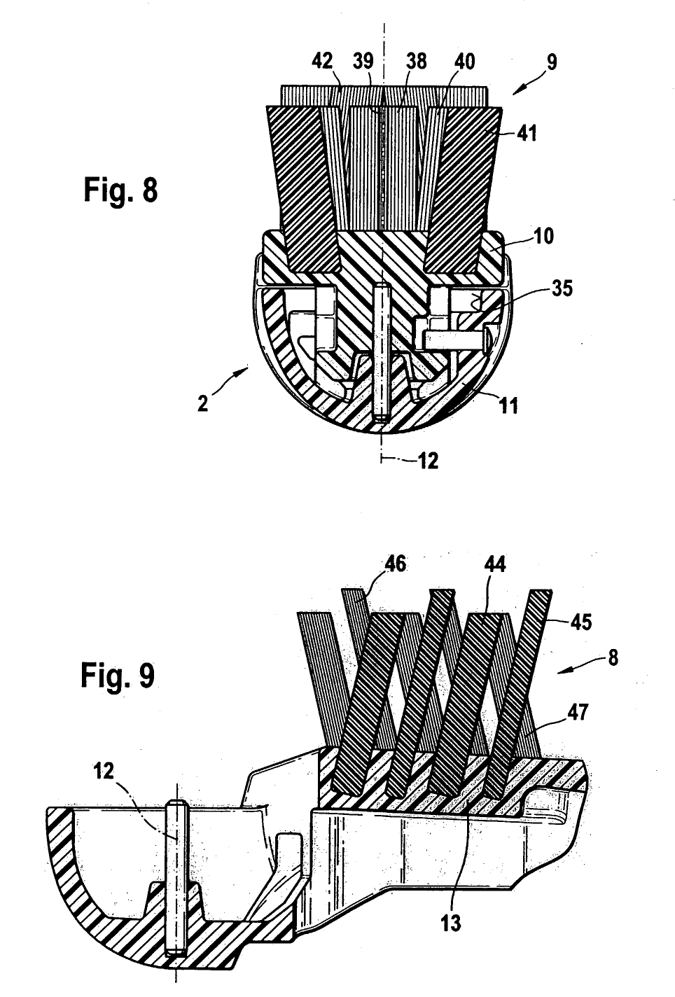

FIG. 8 is a cross-section through the toothbrush head of the preceding figures in the area of the rotating driven bristle cluster along line B-B in FIG. 7, and

FIG. 9 is a cutaway longitudinal section through the toothbrush head similar to FIG. 7, in which the toothbrush head is shown without the rotating drivable bristle cluster.

The toothbrush shown in FIG. 1 includes a handpiece 1 and a toothbrush head 2 that is seated on a brush tube 3, that forms a frontal surface of handpiece 1 and is connected thereto. Handpiece 1 consists of a toothbrush housing 4, in which a battery compartment and a drive motor 5 and disposed one behind the other in axial direction. Motor 5 is switched on and off by means of a switch 6 on the outer mantle of housing 4. Housing 4 is divided into two parts in the area of handpiece 1 and a housing cap 7 can be unscrewed from a housing section that accommodates the motor.

Brush head 2 has two bristle clusters, a fixed bristle cluster 8 and a drivable bristle cluster 9 that is located at the extreme tip of the head and that can be driven to oscillate in rotary fashion about an axis of rotation running perpendicularly to the longitudinal axis of the toothbrush.

As is shown in FIG. 4, drivable bristle cluster 9 is supported on a bristle holder 10 which is essentially disc-shaped where it meets the bristle cluster and is affixed to a brush head holder 11. As FIG. 4 further shows, bristle holder 10 is seated rotatably on a pivot pin 12 that is secured in brush head holder 11.

Fixed bristle cluster 8 is supported by bristle holder 13 that is rigidly connected to brush head holder 11, and which is preferably a directly joined part of brush head holder 11 or is an integral part thereof.

Movable bristle holder 10 is driven in rotating oscillating manner about pivot pin 12 by motor 5 via a transmission member 14 in the form of a drive linkage 15. Drive linkage 15 is configured as a straight metal rod having no protrusions, angles or similar and is supported by a bearing 16 between the motor element and bristle holder 10 in the handpiece 1 or brush tube 3. Bearing 16 is constructed as an elastic bushing in the form of a ring or sleeve that forms a seal between drive linkage 15 and the housing wall of brush tube 3. This arrangement serves to prevent moisture from getting into the interior of handpiece housing 4.

Bearing 16 allows multiaxial oscillation of drive linkage 15 about axes that lie in a plane perpendicular to the longitudinal direction of the toothbrush. Drive linkage 15 is driven by a cam 17 that is non-rotatably affixed to a motor shaft 18, which extends in the longitudinal direction of the toothbrush. Cam 17 causes drive linkage 15 to follow a double conical wobbling and circulatory path, wherein the extremes of the two helices are approximately in the region of bearing 16. The two ends of drive linkage 15 each perform an orbital motion in a plane perpendicular to the longitudinal direction of the toothbrush.

As is shown in FIGS. 2 and 3, brush head 2 is detachably attached to brush tube 3. It may be pulled or pushed off particularly easily, in a manner that will be described. Brush head holder 11 is furnished with an attachment section 19, with which it may be pushed onto or into a corresponding attachment section 20 in the frontal face of brush tube 3. The two attachment sections 19 and 20 are both constructed in approximately hemispherical shape and fit into one another exactly, so that when pressed together they form a hollow profile that is a continuation of brush tube 3.

As is shown in FIGS. 2 to 4, form-fit engaging means are provided on attachment sections 19 and 20 that on the one hand transfer bending forces from brush head 2 to brush tube 3 and on the other hand prevent twisting of brush head 2 relative to brush tube 3. In particular, a sliding guide is provided between brush head holder 11 and brush tube 3. As is shown in FIG. 3, longitudinal ribs 22 and longitudinal grooves 23 are provided on attachment section 19 of brush head holder 11 and on attachment section 20 of brush tube 3, and these engage with each other when brush head 2 is mounted. Brush head 2 may be mounted axially, i.e. in the longitudinal direction of the toothbrush by pushing onto brush tube 3. The axial engagement length of sliding guide 21 is sufficiently long to assure secure retention. It may correspond at least to the diameter of brush tube 3.

In order to secure brush head 2 in an axial direction to handpiece 1 or brush tube 3, a locking mechanism is provided between brush head holder 11 and handpiece 1 that engages automatically when brush head 2 is pushed thereonto in an axial direction and on the other hand may be released again by applying radial pressure to brush tube 3 or brush head holder 11. As FIG. 3 shows, a flexible tongue 30 that flexes towards handpiece 1 is conformed on brush head holder 11 of brush head 2, extending essentially axially and having engaging means 31 at its end that is conformed as a catch hook. Flexible tongue 30 may flex radially, i.e. upwardly as shown in FIG. 3, in order to be able to spring back when brush head 2 is mounted. Complementary locking means to engaging means 31 are provided on brush tube 3. If a catch hook is provided on flexible tongue 30, an undercut, particularly a perforation through the housing is provided in brush tube 3 as locking means 32. When brush head 2 is mounted, the flexible tongue 30 with engaging means 31 protrudes through the wall of brush tube 3. When catch hook 32 reaches perforation 31, flexible tongue 30 springs radially outwards and catch hook 31 snaps into place. The operation may be assisted if reverse bevels are also provided on flexible tongue 30 and on catch hook 31.

When brush head 2 is mounted, transmission member 14 is simultaneously coupled with movable bristle holder 10. The drive coupling takes place directly on bristle holder 10. As FIG. 4 shows, a recess is provided in a mantle surface of bristle holder 10 opposite handpiece 1 to receive the end of transmission member 14 closest to the bristle holder. In the embodiment shown in the drawing, recess 33 in bristle holder 10 is a longitudinal slot or a groove extending parallel to pivot pin 12, and in which the end of drive rocker 15 closest to the bristle holder may move in both directions parallel to pivot pin 12. Slot-shaped recess 33 flares in a V shape towards transmission member 14. The edges of recess 33 form a trapping bevel 34 that, when brush head 2 is mounted on handpiece 1, grip the end of drive linkage 15 so that this engages with slot-shaped recess 33. In order to prevent bristle holder 10 from twisting too far when brush head 2 is disassembled, with the consequence that drive linkage 15 can no longer be engaged when the head is mounted again, bristle holder 10's range of rotation about pivot pin 12 is restricted. Corresponding rotation stops 35 on bristle holder 10 and brush head holder 11 limit the extent of rotation and ensure that recess 33 is always in line with the mounting direction.

The end of drive rocker 15 closest to the bristle holder is shaped as a hollow hemisphere. The ball head mates precisely with recess 33, i.e. the width of recess 33 perpendicular to the longitudinal midplane of the toothbrush 36 is commensurate with the diameter of ball head 36, with some play if necessary. The drive coupling formed between recess 33 and ball head 36 thus transfers forces perpendicularly to the longitudinal axis of the toothbrush, but no forces in the longitudinal direction of the toothbrush. As drive rocker 15 follows its double conical path, ball head 36 slides down the wall of recess 33, since transmission member 14 cannot rotate about the longitudinal axis. The backward and forward motion of ball head 36 is compensated by the longitudinal slot-shaped construction of recess 33, i.e. such motion is not transferred because the drive coupling moves freely in this respect. However, drive movements transverse to the longitudinal, i.e. perpendicular to the illustrated plane in FIG. 4, are transferred, thereby lending an oscillating rotating movement to bristle holder 10.

As FIG. 4 shows, the edges of attachment sections 19 and 20 of brush head 2 and brush tube 3 respectively mate exactly in the assembled condition, wherein the edges may have an overlapping, graduated profile 37.

Bristle clusters 8 and 9 of brush head 2 are distinguished by the special configuration of the bristle tufts and bristles arranged thereon, and will be explained in detail in the following with reference to the drawing:

Rotating oscillating drivable bristle cluster 9 has a shape that is generally approximately cylindrical and is formed by a plurality of bristle tufts having varying inclinations, differing heights and differing cross-sections.

As is shown in FIG. 6, central first bristle tufts 38 are arranged centrally about central pivot pin 12. They extend perpendicularly to the plane defined by bristle holder 10 and have an approximately round or slightly oval cross-section. Four of the first bristle tufts 38 are provided. They are arranged centrally about pivot pin 12. Adjacent first bristle tufts 38 are second bristle tufts 39 which, when the bristle holder 10 is in the unrotated position, lie on the longitudinal midplane of the toothbrush and are disposed longitudinally in front of and behind first bristle tufts 38. As FIG. 6 shows, second bristle tufts 39 have an oval cross-section, with a longitudinal axis extending transversely to -the longitudinal axis of the toothbrush. Second bristle tufts 39 are also arranged perpendicularly to the plane defined by bristle holder 10. They are at a greater distance from pivot pin 12 than first bristle tufts 38. The ratio of shape length to shape width is about 2, as is shown in FIG. 6.

The other bristle tufts of the driven bristle cluster are inclined, and are inclined in different directions. Fourth bristle tufts 40, which are arranged radially outside first bristle tufts 38 in a second bristle tuft ring so to speak, have an approximately circular cross-section and are inclined radially outwards, i.e. their distal working ends are located farther from the bristle holder's pivot pin than their attachment sections which are affixed to bristle holder 10. The angle of inclination is acute and is less than 20°.

Third bristle tufts 41 are also inclined radially outwards. However, they have an oval shape or an elongated cross-section, wherein the longitudinal axis of the cross-section is aligned radially. The cross-section of the third bristle tufts is approximately two to three times, preferably two times, as long as it is wide. Third bristle tufts 41 are located radially outside first bristle tufts 38 and adjacent thereto on an axis of symmetry of the bristle cluster extending transverse to the longitudinal direction of the toothbrush.

The remaining bristle tufts of bristle cluster 9 are also inclined, however they are inclined in a radial direction about pivot pin 12. They form the outer margin or ring of bristle cluster 9.

Fifth bristle tufts 42 have an oval shape or an elongated cross-section, which is aligned approximately tangentially to the edge of bristle holder 10. The cross-section of bristle tufts 42 approximately two to three times, preferably two times, as long as it is wide. As FIG. 6 shows, fifth bristle tufts 42 are arranged in pairs in the region of the longitudinal axis of the toothbrush when bristle cluster 9 is unrotated. They are inclined in opposing pairs, so that their distal, working ends are closer together than their attachment sections which are secured in bristle holder 10.

Finally, sixth bristle tufts 43 are provided that are also located on the outer edge of the bristle cluster and are inclined in a radial direction about pivot pin 12. However, they have an approximately circular cross-section and are arranged in pairs on both sides of third bristle tufts 41, and are also inclined in the opposite direction thereto. The angles of inclination of outlying bristle tufts 43 and 42, which are radially inclined, are also acute and are preferably less than 20° relative to the perpendicular plane defined through bristle holder 10. The cross-sectional area of the elongated bristle tufts (39, 41, 42) is preferably about twice that of the approximately circular bristle tufts (38, 40, 43).

As is shown in FIG. 7, the bristle tufts arranged on movable bristle holder 10 are in two lengths. Fifth bristle tufts 42, which are disposed longitudinally at the outer front and back extremities, and whose distal ends are all on one level, are longer than the other bristle tufts. The distal ends of fifth bristle tufts 42 define one level. The height difference between the bristle tufts is in the range from 0.5 mm to 2.5 mm, preferably approximately about 1.0 mm to 1.5 mm. In the embodiment shown, it is 1.2 mm.

The bristle tufts of the second, fixed bristle cluster 8 also have varying cross-sections with regard to shape and area and are also variously inclined. Bristle tufts of various lengths are also provided as will be described in the following.

As is shown in FIG. 6, three roughly adjacent rows of bristle tufts are provided in the fixed bristle cluster, all extending in the longitudinal direction of the toothbrush. The middle row lies essentially the longitudinal midplane, while the two outer rows are arranged at a distance on either side thereof.

In the middle row of bristles, all bristle tufts are inclined towards handpiece 1. All bristle tufts have an elongated or oval cross-section, but different cross-sectional areas. First bristle tufts 44 of fixed bristle cluster 8 have an oval cross-section, wherein their longitudinal axis is approximately twice as long, as their transverse axis. First bristle tufts 44 alternate in the middle row with bristle tufts 45, referred to in the following as the fourth bristle tufts, and which are also inclined backwards towards the handpiece. Fourth bristle tufts 45 also have an oval cross-section, but have a considerably thinner construction and have a smaller cross-sectional area than the first bristle tufts. According to the embodiment shown, the cross-longitudinal cross-section is—roughly speaking—approximately three times as long as it is wide. The length of the oval cross-section is thus slightly smaller than the cross-sectional length of first bristle tufts 44.

The two outer rows of the bristle tufts of fixed bristle cluster 8 consist of second and third bristle tufts. Second bristle tufts 46 have an oval cross-section with a relatively slender shape. The longitudinal axis of the elongated cross-sectional contour is approximately three times the width of the cross-sectional contour. Third bristle tufts 47 have a roughly circular cross-section, wherein the diameter of the cross-section is slightly greater than half the longitudinal axis of the cross-section of second bristle tufts 46. Bristle tufts 44 preferably have a cross-sectional area that is about twice the size of bristle tufts 47. The cross-sectional areas of bristle tufts 45 and 46 are roughly the same size. As is shown in FIG. 6, third bristle tufts 47 are arranged at varying distances from the longitudinal midplane of brush head 2. The distance from the longitudinal midplane decreases towards handpiece 1. However, third bristle tufts 47 are still arranged in consecutive rows to such a degree that their contour is more or less completely overshadowed by the contour of the much wider second bristle tufts 46. Second and third bristle tufts 46 and 47 are each inclined forward at an acute angle, that is towards drivable bristle cluster 9, and at an acute angle, that may preferably be between 12° and 15°. All bristle tufts of in fixed bristle cluster 8 are preferably arranged on the longitudinal midplane of brush head 2 or inclined in planes parallel thereto. In contrast, all bristle tufts in rotating bristle cluster 9 are inclined variously or are arranged in a different alignment.

The bristle tufts of fixed bristle cluster 8 define two working planes, as is shown in FIG. 7. The round, third bristle tufts 47 in the outer rows as well as the thicker, particularly oval first bristle tufts 44 in the middle row are shorter and their distal working ends define a lower level, which matches the level defined by the first, second, third, fourth and sixth bristle tufts on rotating bristle cluster 9. On the other hand, a higher, second level is defined by the longer fourth bristle tufts 45 in the middle row and the second bristle tufts 46 in the two outer rows. This higher level matches the level that is defined by the longer fifth bristle tufts of movable bristle cluster 9. In fixed bristle cluster 8, therefore, it may be said that the more slender, oval bristle tufts are longer than the thicker bristle tufts.

As is further shown in FIG. 7, the upper surface of fixed bristle holder 13 slopes downward in the direction of handpiece 1. The length of the bristle tufts in fixed bristle cluster 8 increases correspondingly in the direction of handpiece 1. From the longitudinal direction of the toothbrush to the parallel outer rows, the length of the bristles increases by approximately 0.5 to 1.0 mm, preferably by 0.5 mm.

Unlike drivable bristle cluster 9, fixed bristle cluster 8 does not have a round shape but an overall elongated shape that surrounds rotating bristle cluster 9 at the extremity closest thereto.

Of course, the brush head 2, particularly fixed bristle holder 13 and drivable bristle holder 10 may be made from moulded plastic parts. They are preferably made from POM in order to allow a low material thickness. The wall thickness may be in the range from 2.5 mm to 3.5 mm.

The length of the bristles or filaments may be adapted to different marginal conditions. In a preferred embodiment of the invention, the length of the bristles, that is the longer bristles that define the higher level, is in the range from 7.5 mm to 9.0 mm, preferably about 8.0 mm to 8.5 mm and especially about 8.3 mm.

The bristle tufts are preferably attached to the bristle holders by means of a small anchoring plate in an anchoring process, wherein the bristle tufts with elongated or oval cross-section differing from the circular shape are composed of multiple bristle tufts, which are separated from each other by dividers in the bristle tuft recess, as is known from German Patent No. DE 10015062 A1, to which explicit reference is herewith made.

In the case of the slender bristle tufts with elongated cross-section, i.e. second bristle tufts 46 and fourth bristle tufts 45 on fixed bristle cluster 8, it is preferable to provide that the small anchor plates extend longitudinally to the cross-section. In order to avoid tearing the bristle holder, these slender bristle tufts are arranged with their longitudinal axes slightly offset, so that the small anchor plates are not arranged on a single line.

Fixed bristle holder 13 is preferably also constructed unevenly in a direction transverse to the longitudinal axis of the brush head. In particular, it may slope downwards towards the outer edge so that the outlying bristles are longer than the more centrally disposed bristles, and are thus more flexible. The surface of fixed bristle holder 13 may be convex or arched in a direction transverse to the longitudinal axis. The three-dimensionally curved structure of fixed bristle holder 13 and the use of POM enables the brush head to be have an extremely compact form, thereby enabling better cleaning performance.

The bristles in bristle tufts 47, 46 preferably have a diameter of (7±1)×10⁻³ inches, whereas the diameter of the bristles in bristle tufts 44, 45 is preferably, (6±1)×10⁻³ inches.

1. A toothbrush head for an electric toothbrush, with a brush head holder (11) on which a bristle holder (10) is arranged with a movable bristle cluster (9), wherein the brush head holder has an attachment section (19) for detachable attachment to a handpiece (1) of the toothbrush, and a drive coupling (33, 36) is provided for coupling the bristle holder (10) to a drive (5, 14) arranged on the handpiece, characterised in that engaging means (31) or clamping means are provided on the preferably rigid attachment section (19) that, when bristle holder (10) is joined to the handpiece (1) of the toothbrush in a preferably essentially linear, axial movement, engage with locking means (32) provided thereon or assure a clamping or frictional connection of the brush head holder (10) with the handpiece (1).

2. The toothbrush head according to the preceding claim, wherein engaging means (31) may be released by radial pressure on the brush head holder (11) and/or on the handpiece (1) of the toothbrush, wherein preferably a flexible tongue (30) with a catch hook (31) is provided as a locking means, and which is constructed to flex radially and is engageable with a locking recess (32) provided on the handpiece (1).

3. The toothbrush head according to the preamble of claim 1, wherein the drive coupling (33, 36) is constructed such that only forces and motions perpendicular to the longitudinal axis of the toothbrush are transferred from the drive element (14) on the handpiece side to the bristle holder (10).

4. The toothbrush head according to any of the preceding claims, wherein the drive coupling (33, 36) is provided directly on the brush holder (10) and the toothbrush head is constructed without its own driveshafts, drive rockers, drive rods and similar.

5. The toothbrush head according to any of the preceding claims, wherein the drive coupling (33, 36) is furnished with coupling devices that are couplable with a drive rocker (15) on the handpiece side.

6. The toothbrush head according to any of the preceding claims, wherein a recess (33) is conformed in the bristle holder (10) as the drive coupling, with which a drive element (14) on the handpiece side engages when the toothbrush head is mounted on the handpiece (1).

7. The toothbrush head according to any of the preceding claims, wherein a coupling guide (34, 35) is attached to the bristle holder (10) and guides the drive coupling and a drive element on the handpiece side into each other the toothbrush head is mounted, wherein a motion limiter (35) is preferably attached to the bristle holder (10) and limits its range of motion, and insert bevels (34) are provided on the bristle holder (10) that grip the drive element (14) on the handpiece side the toothbrush head is mounted.

8. The toothbrush head according to any of the preceding claims, wherein a longitudinal slot (33) is provided in a mantle surface of the bristle holder (10) as the drive coupling, and with which a transmission member (14) on the handpiece side engages when the toothbrush head is mounted.

9. The toothbrush head according to any of the preceding claims, wherein the bristle holder (10) is arranged about a pivot pin (12) transverse to the longitudinal direction of the brush head holder (11) on which it rotates.

10. The toothbrush head according to any of the preceding claims, wherein the bristle holder (10) is secured on the brush head holder (11) immovably in the direction of the pivot pin and the drive coupling (33, 36) is constructed to be freely movable in the direction of the pivot pin (12).

11. The toothbrush head according to claim 9, wherein the bristle holder (10) is arranged movably in the direction of the pivot pin (12) and the drive coupling has meshing means for the transmission of drive motions and forces in the direction of the pivot pin (12).

12. The toothbrush head according to any of the preceding claims, wherein the brush head holder (11) is furnished with a rotational encoding, particularly a mounting guide (21) preferably in form of longitudinal ribs (22) and/or grooves (23).

13. The toothbrush head preferably according to any of the preceding claims for an electric toothbrush, with a brush head holder (11) on which a motor drivable brush holder (10) is movably, and particularly in oscillating, rotating fashion, arranged with a bristle cluster (9), characterised in that several groups (38-43) of bristle tufts are attached to the bristle holder (10) and are inclined in various directions.

14. The toothbrush head according to the preceding claim, wherein the groups (38-43) of bristle tufts inclined in different directions have varying cross-sections.

15. The toothbrush head according to any of the preceding claims, wherein a stationary bristle holder (13) is affixed on the brush head holder (11) adjacent the movable bristle holder (10), wherein several groups (44-47) of bristle tufts are attached to the stationary bristle holder (13), and are inclined in varying directions.

16. The toothbrush head according to the preceding claim, wherein the different groups (44-47) of bristle tufts have different cross-sections.

17. The toothbrush head according to any of the preceding claims, wherein the bristle tufts on the movable bristle holder (10) are inclined in directions other than the those of the bristle tufts on the fixed bristle holder (13).

18. The toothbrush head according to any of the preceding claims, wherein bristle tufts (39; 41; 42; 44; 45; 46) with a cross-section varying from the circular form, particularly an elongated, oval or rectangular cross-section are provided on the movable bristle holder (10) and/or on the stationary bristle holder (13).

19. The toothbrush head according to any of the preceding claims, wherein bristle tufts are provided on the movable bristle holder (10) and/or on the stationary bristle holder (13), the distal working ends of which reach different heights above the bristle holder (10; 13), wherein preferably the bristle tufts of the fixed bristle holder (13), whose distal ends reach the same level, and bristle tufts of the movable bristle holder (10), whose working ends also reach the same level, define a common level.

20. The toothbrush head according to any of the preceding claims, wherein a first group of bristle tufts (38) on the movable bristle holder (10) extends parallel to the axis of motion (12) of the bristle holder, and preferably has an approximately round cross-section.

21. The toothbrush head according to any of the preceding claims, wherein a second group of bristle tufts (39) on the movable bristle holder extends parallel to the axis of motion (12) of the bristle holder, and preferably has an approximately oval cross-section.

22. The toothbrush head according to any of the preceding claims, wherein a third group of bristle tufts (41) arranged on the movable bristle holder is inclined at an acute angle to the axis of motion (12), is particularly inclined radially outwards, and preferably has an oval cross-section with a radially extending longitudinal axis.

23. The toothbrush head according to any of the preceding claims, wherein a fourth group of bristle tufts (40) arranged on the movable bristle holder is inclined at an acute angle to the axis of motion (12), particularly inclined radially outwards, and preferably has an approximately circular cross-section.

24. The toothbrush head according to any of the preceding claims, wherein a fifth group of bristle tufts (42) arranged on the movable bristle holder is inclined at an acute angle to the axis of motion (12), particularly inclined in a peripheral direction about the axis of motion (12), preferably has an oval cross-section with longitudinal axis aligned in peripheral direction, wherein preferably adjacent bristle tufts (42) are oppositely inclined.

25. The toothbrush head according to any of the preceding claims, where a sixth group of bristle tufts (43) arranged on the movable bristle holder is inclined at an acute angle to the axis of motion (12), especially is inclined in peripheral direction about the axis of motion (12), and preferably has a round cross-section.

26. The toothbrush head according to any of the preceding claims 20 to 25, wherein the first group of bristle tufts (38) is arranged at the center of the bristle cluster (9).

27. The toothbrush head according to any of the preceding claims 20 to 26, wherein the second group of bristle tufts (39) is adjacent the first group of bristle tufts (38) and is arranged radially outside thereof and is preferably located in front of and behind the first group in the longitudinal direction of the brush head.

28. The toothbrush head according to any of the preceding claims 20 to 27, wherein the third group of bristle tufts (41) is adjacent and radially outside the first group of bristle tufts (38) and is preferably located to the right and left of the first group in a longitudinal direction of the brush head.

29. The toothbrush head according to any of the preceding claims 20 to 28, wherein the fourth group of bristle tufts (40) is adjacent and radially outside the first group of bristle tufts (38), and is preferably arranged between the second and third groups of bristle tufts, (39; 41) in radial direction .

30. The toothbrush head according to any of the preceding claims 20 to 29, wherein the fifth group of bristle tufts (42) is arranged radially outwards, is particularly arranged radially outside the second and/or fourth group of bristle tufts (39; 40), and preferably in front of and behind the first and/or second group of bristle tufts, (38; 39) in longitudinal direction of the brush head.

31. The toothbrush head according to any of the preceding claims 20 to 30, wherein the sixth group of bristle tufts (43) is arranged radially outwards, particularly radially outside the second and/or fourth group of bristle tufts (39; 40), and is preferably located to the right and left of the first and/or second bristle tufts (38; 39) in longitudinal direction.

32. The toothbrush head according to any of the preceding claims, wherein a first level is defined by bristle tufts (42) lying outwardly radially and/or at the front and back in longitudinal direction of the brush head, and a second level is defined by bristle tufts, (38; 39; 40; 41) lying inwardly radially and/or to the right and left in longitudinal direction, wherein the first level is preferably higher above the bristle holder than the second level, particularly with a height difference of approximately 0.5 to 2.5 mm, preferably 1.2 mm.

33. The toothbrush head according to any of the preceding claims, wherein a first group of bristle tufts (44) of the fixed bristle holder (13) is inclined at a first acute angle to the perpendicular on the bristle holder (13), preferably inclined backwards in the longitudinal direction of the brush, and preferably has an oval cross-section with longitudinal axis extending perpendicularly to the brush's longitudinal direction.

34. The toothbrush head according to any of the preceding claims, wherein a second group of bristle tufts (46) of the fixed bristle holder (13) is inclined at a second acute angle to the perpendicular on the bristle holder (13), preferably inclined forward in the brush's longitudinal direction, preferably has an oval cross-section with longitudinal axis extending perpendicularly to the brush's longitudinal direction.

35. The toothbrush head according to any of the preceding claims, wherein a third group of bristle tufts (47) of the fixed bristle holder (13) are is inclined at an acute angle to the perpendicular on the bristle holder (13), preferably inclined forward in the brush's longitudinal direction, and preferably has a round cross-section.

36. The toothbrush head according to any of the preceding claims, wherein a fourth group of bristle tufts (45) of the fixed bristle holder (13) is inclined at an acute angle to the perpendicular on the bristle holder (13), preferably inclined backwards in the brush's longitudinal direction, and preferably has an oval cross-section with longitudinal axis running transverse to the brush's longitudinal direction.

37. The toothbrush head according to the preceding claim, wherein the fourth group of bristle tufts (45) and the first group of bristle tufts (44) of the fixed bristle holder are arranged approximately in rows one behind the other, preferably alternating.

38. The toothbrush head according to any of the preceding claims, wherein the second and third group of bristle tufts (46; 47) on the fixed bristle holder are arranged in at least one row, preferably in two consecutive rows, and particularly are alternating.

39. The toothbrush head according to any of the preceding claims, wherein the first and fourth groups of bristle tufts (44; 45) on the fixed bristle holder (13) are arranged centrally.

40. The toothbrush head according to any of the preceding claims, wherein the second and/or third group of bristle tufts (46; 47) of the fixed bristle holder (13) are arranged at the external edges.

41. The toothbrush head according to any of the preceding claims, wherein the angles of inclination of the bristle tufts (44-47) on the fixed bristle holder (13) lie in parallel planes, and preferably are between 10° and 20°, especially about 12° to 15°.

42. The toothbrush head according to any of the preceding claims, wherein the bristle tufts (44-47) on the fixed bristle holder (13) have three different cross-sections, particularly two differently oval cross-sections and one round cross-section.

43. The toothbrush head according to any of the preceding claims, wherein the free length of the bristles of the bristle tufts (44-47) on the fixed bristle holder (13) increase from the brush head in the direction of the handpiece (1), and/or increase outwardly in a direction transverse to the longitudinal direction.

44. The toothbrush head according to any of the preceding claims, wherein a three-dimensionally moulded, particularly a convex fixed bristle-holder (13) is provided.

45. The toothbrush head according to any of the preceding claims, wherein a fixed bristle holder (13) that is inclined with respect to the movable bristle holder (10), especially a fixed bristle holder (13) that slopes downwards towards the handpiece (1), is provided.

46. The toothbrush head according to any of the preceding claims, where bristle tufts having different bristle types, especially different bristle diameters are provided, wherein bristle tufts lying outwardly in longitudinal direction of the brush head have preponderantly thicker bristles those located inwardly, wherein the bristles are preferably made of nylon.

47. The toothbrush head according to any of the preceding claims, wherein the bristle tufts of the fixed bristle cluster (8) and the bristle tufts of the drivable bristle cluster (9) define two common working levels with their distal ends.

48. The toothbrush head according to any of the preceding claims, wherein the bristle holders (10; 13) are made from POM.

49. The toothbrush head according to any of the preceding claims, wherein a part of the bristle tufts, especially outlying bristle tufts are capable of indicating wear.

50. A handpiece of an electric toothbrush for a toothbrush head according to any of the preceding claims, with a housing (4) in which a drive (5; 14) is provided to drive the bristle holder (10) on the toothbrush head (2), wherein the housing (4) has a attachment section (20) for attaching the toothbrush head (2), characterised in that locking means (32) or clamping means are provided on attachment section (20) that engage with engaging means (31) provided on the handpiece or assure a clamping connection when the brush head is joined to the handpiece of the toothbrush in a preferably essentially linear, axial movement.

51. The handpiece according to the preceding claim, wherein the locking means (32) are releasable by radial pressure on the brush head and/or the handpiece of the toothbrush.

52. The handpiece according to any of the preceding claims, wherein the drive is furnished with a transmission member (14) that protrudes from the frontal surface of attachment section (20) in housing (4), that is couplable with the bristle holder (10) on the brush head (2), and particularly engages with a recess (33) in the bristle holder (10) when the brush head is mounted on the handpiece.

53. The handpiece according to any of the preceding claims, wherein the drive has a drive rocker (15) as a transmission member for transferring a drive motion from motor (5) to the bristle holder (10) which is arranged to oscillate in housing (4), wherein preferably the drive rocker (14) is supported to allow multiaxial movement and is drivable by a cam (17) such that it follows a double conical path.

54. The handpiece according to any of the preceding claims, wherein the drive transmission member of the handpiece to be coupled with the bristle holder (10) has a hollow hemispherical end (36), that may be engaged in articulated manner with a slot (33) in the bristle holder.

55. The toothbrush with a handpiece according to any of the preceding claims and with a toothbrush head according to any of the preceding claims.
